(19) United States
(12) Patent Application Publication
(10) Pub. No.: US 2016/0034076 A1
(43) Pub. Date: Feb. 4, 2016

(54) TOUCH DISPLAY DEVICE

(71) Applicant: InnoLux Corporation, Miao-Li County (TW)

(72) Inventors: Chuan-Chi CHIEN, Miao-Li County (TW); Hsiu-Ting HSU, Miao-Li County (TW)

(21) Appl. No.: 14/806,949

(22) Filed: Jul. 23, 2015

(30) Foreign Application Priority Data
Jul. 29, 2014 (TW) 103125811

(51) Int. Cl. G06F 3/047; G09G 5/00

(52) U.S. Cl. CPC G06F 3/047; G09G 5/003; G09G 2300/0426

(57) ABSTRACT

A touch display device is provided. The touch display device includes a display panel and a touch sensor disposed above the display panel. The touch sensor includes a plurality of first electrode units arranged along a first direction and separated from each other, and a bridge portion electrically connecting the first electrode units with each other. A plurality of second electrode units are arranged along a second direction perpendicular to the first direction and connected to each other through a connection portion. The connection portion intersects the bridge portion. An isolation portion is disposed between the bridge portion and the connection portion. A first distance is between the first electrode unit and the adjacent second electrode unit. A second distance is between the first electrode unit and the adjacent connection portion. The second distance is shorter than the first distance.

### CROSS REFERENCE TO RELATED APPLICATIONS

This Application claims priority of Taiwan Patent Application No. 103125811, filed on Jul. 29, 2014, the entirety of which is incorporated by reference herein.

### BACKGROUND OF THE INVENTION

1. Field of the Invention

The present invention relates to touch display device technology, and in particular to the structural designs of a touch sensor in touch display devices which can prevent the visible effect of bridge portions of the touch sensor.

2. Description of the Related Art

Along with developments in the electronics industry, various digital products, such as mobile phones, tablet computers, digital cameras and other electronic devices, have a requirement for touch functionality. Using touch sensors on electronic products can provide faster and more convenient operation.

Touch sensors can be roughly divided into resistive-type and capacitive-type touch technologies. Currently, the capacitive-type touch technology is a major technology for touch sensors. In capacitive-type touch sensors, a transparent conductive layer is patterned to form a plurality of electrode patterns along the X-axial and Y-axial directions. Touch positions can be detected by the electrode patterns of the X-axial and Y-axial directions. In order to avoid a short circuit occurring at the intersection of the electrode patterns of the X-axial and Y-axial directions, the electrode patterns in one direction of the X-axial and Y-axial directions are designed to be continuous, and the electrode patterns in the other direction of the X-axial and Y-axial directions are designed to be separated. A metal bridge line is used to connect the adjacent and separated electrode patterns together. An insulating layer is disposed between the metal bridge line and a connection portion of the electrode patterns in the other direction for isolating the metal bridge line from the connection portion.

The metal bridge line is usually required to have a certain length to ensure the conductivity of the metal bridge line for electrical connection. However, the metal bridge line with a certain length will cause a visible problem in touch sensors. As a result, the appearance of the touch sensors is affected by the metal bridge line. In addition, the metal bridge line also affects the image display quality of touch display devices.

### SUMMARY OF SOME EMBODIMENTS OF THE INVENTION

The disclosure provides structural designs of touch sensors in touch display devices. The disclosure uses a layout for touch-sensing electrode patterns to reduce the length of a bridge portion of the touch sensors. Moreover, the disclosure uses an indentation of an isolation portion at the intersection of the touch-sensing electrode patterns along the X-axial and Y-axial directions to further reduce the length of the bridge portion of the touch sensors. Therefore, the visible problem of the bridge portion in the conventional touch sensors is overcome. The visual effect of the touch sensors for users is thereby improved.

In some embodiments of the disclosure, a touch display device is provided. The touch display device comprises a display panel and a touch sensor disposed above the display panel. The touch sensor comprises a plurality of first electrode units arranged along a first direction and a bridge portion electrically connecting the adjacent first electrode units with each other. The touch sensor further comprises a plurality of second electrode units arranged along a second direction perpendicular to the first direction, and a connection portion electrically connecting the adjacent second electrode units with each other. The connection portion intersects the bridge portion. The touch sensor also comprises an isolation portion disposed between the bridge portion and the connection portion. The first electrode unit is separated from the adjacent second electrode unit by a first distance. The first electrode unit is separated from the adjacent connection portion by a second distance. The second distance is shorter than the first distance.

In some embodiments of the disclosure, a touch display device is provided. The touch display device comprises a display panel and a touch sensor disposed above the display panel. The touch sensor comprises a plurality of first electrode units arranged along a first direction, and a bridge portion electrically connecting the adjacent first electrode units with each other. The touch sensor further comprises a plurality of second electrode units arranged along a second direction perpendicular to the first direction, and a connection portion electrically connecting the adjacent second electrode units with each other. The connection portion intersects the bridge portion. The touch sensor also comprises an isolation portion disposed between the bridge portion and the connection portion. The isolation portion overlaps with the bridge portion. The isolation portion has an indentation at an end of the isolation portion along the first direction. The indentation has a width that is greater than the width of the bridge portion.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a plane view of a portion of a touch sensor according to some embodiments of the disclosure;

FIG. 2 shows a cross section of a touch sensor along a cross section line 2-2′ of FIG. 1 according to some embodiments of the disclosure;

FIG. 3 shows a plane view of a portion of a touch sensor according to some embodiments of the disclosure;

FIGS. 4A-4C show plane views of a bridge portion and an isolation portion of touch sensors according to some embodiments of the disclosure;

FIG. 5 shows a plane view of a portion of a touch sensor according to some embodiments of the disclosure;

FIG. 6 shows a cross section of a touch display device according to some embodiments of the disclosure, in the touch display device, the touch sensor is a GG-type touch sensor which has touch-sensing elements formed on a glass substrate between a cover plate of a touch panel and a display panel;

FIG. 7 shows a cross section of a touch display device according to some other embodiments of the disclosure, in the touch display device, the touch sensor is a TOD-type touch sensor which has touch-sensing elements formed on a display panel; and

FIG. 8 shows a cross section of a touch display device according to some other embodiments of the disclosure, in the touch display device, the touch sensor is a WIS-type touch sensor which has touch-sensing elements formed on a cover plate of a touch panel.

### DETAILED DESCRIPTION OF THE INVENTION

The following description is of the contemplated mode of carrying out the structure designs and fabrication methods of some embodiments of the touch sensors of the disclosure. This description is made for the purpose of illustrating the general principles of the disclosure and should not be taken in a limiting sense. The scope of the invention is best determined by reference to the appended claims.

Moreover, in the descriptions of the embodiments that follow, the orientations of “on”, “over”, “above”, “under” and “below” are used for representing the relationship between the relative positions of each element in the touch sensors, and not used to limit the present disclosure. In addition, a first element formed “on”, “over”, “above”, “under” or “below” a second element includes embodiments having the first element in direct contact with the second element, or embodiments having additional elements inserted between the first element and the second element so that the first element is not in direct contact with the second element.

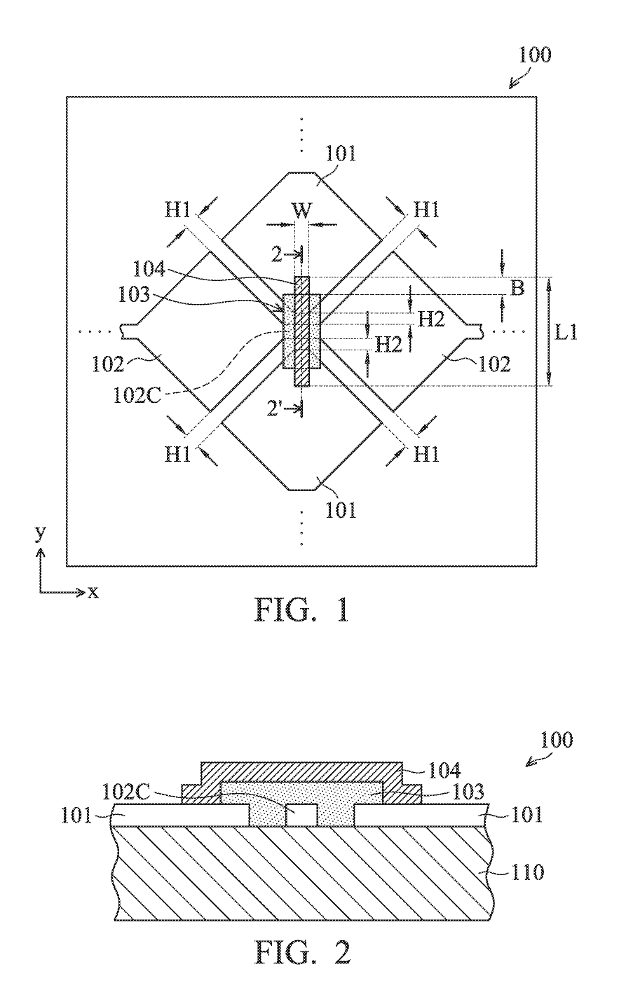

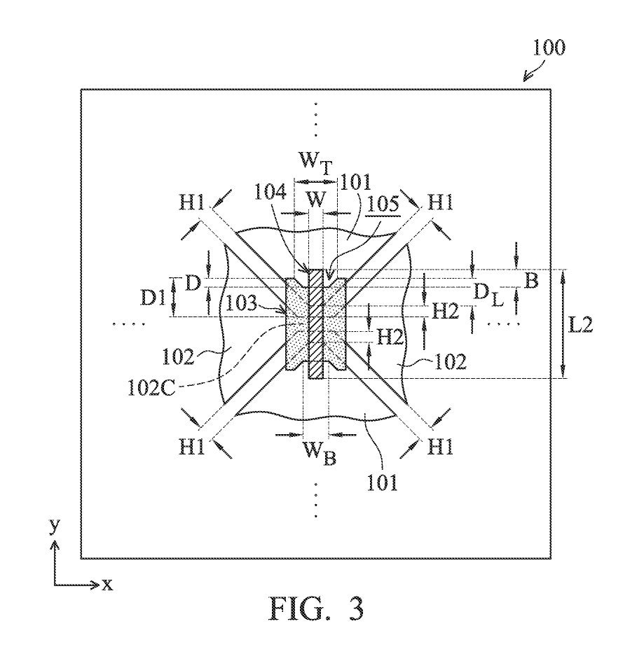

Referring to FIG. 1 and FIG. 2, FIG. 1 shows a plane view of a portion of a touch sensor 100 according to some embodiments of the disclosure. FIG. 2 shows a cross section of a portion of the touch sensor 100 along a cross section line 2-2′ of FIG. 1 according to some embodiments of the disclosure. The touch sensor 100 includes a plurality of first electrode units 101 arranged along a first direction, for example the Y-axial direction. The adjacent first electrode units 101 are separated from each other and a bridge portion 104 is disposed for electrically connecting the adjacent first electrode units 101 together. The touch sensor 100 further includes a plurality of second electrode units 102 arranged along a second direction, for example the X-axial direction. The second direction is perpendicular to the first direction. The adjacent second electrode units 102 are connected with each other by a connection portion 102C. The connection portion 102C intersects the bridge portion 104. Although FIG. 1 only shows two first electrode units 101 and two second electrode units 102, the touch sensor 100 actually includes more than two first electrode units 101 arranged into one column of an electrode pattern in the Y-axial direction, and more than two second electrode units 102 arranged into one row of an electrode pattern in the X-axial direction. In addition, the touch sensor 100 includes a plurality of columns of the electrode patterns in the Y-axial direction and a plurality of rows of the electrode patterns in the X-axial direction.

In some embodiments, the first electrode units 101, the second electrode units 102 and the connection portions 102C of the second electrode units 102 can be made of the same layer of a transparent conductive material layer, such as an indium tin oxide (ITO) layer or an indium zinc oxide (IZO) layer. The transparent conductive material layer is patterned by a photolithography and etching process. An isolation portion 103 is disposed at the intersection of the electrode patterns in the Y-axial direction and the electrode patterns in the X-axial direction. Thus, there is no short circuit occurring at the intersection of the electrode patterns in the Y-axial direction and the electrode patterns in the X-axial direction. The isolation portion 103 is disposed along a third direction, for example a Z-axial direction, between the bridge portion 104 and the connection portions 102C of the second electrode units 102. The third direction is perpendicular to the first direction and the second direction.

In some embodiments, the bridge portion 104 can be made of a metal material. The bridge portion 104 can be formed by depositing a metal layer and using a photolithography and etching process to pattern the metal layer. In some other embodiments, the bridge portion 104 can be made of a transparent conductive material. The bridge portion 104 can be formed by depositing a transparent conductive material layer and using a photolithography and etching process to pattern the transparent conductive material layer. The isolation portion 103 is made of an insulating material. In some embodiments, the isolation portion 103 can be made of an insulating photoresist by a photolithography process. In some other embodiments, the isolation portion 103 can be made of an organic or an inorganic insulating material by a printing process. The isolation portion 103 can also be formed by a deposition, photolithography and etching process.

As shown in FIG. 1, the first electrode unit 101 has the shape of a rhombus with a cut-off corner. The cut-off corner of the rhombus is adjacent to the connection portions 102C of the second electrode units 102. The first electrode unit 101 is separated from the adjacent second electrode unit 102 by a first distance H1. The first electrode unit 101 is separated from the adjacent connection portion 102C by a second distance H2. According to some embodiments of the disclosure, the second distance H2 is shorter than the first distance H1. In some other embodiments, the shapes of the first electrode unit 101 and the second electrode units 102 can be changed to satisfy different design requirements. The shape of touch-sensing electrodes of touch sensors of the disclosure is not limited to that in FIG. 1.

Referring to FIG. 1, the bridge portion 104 has a width W along the X-axial direction. The bridge portion 104 covers the isolation portion 103 and has a distance B in the area of the first electrode unit 101 without overlapping the isolation portion 103 along the Y-axial direction. The bridge portion 104 has a total length L1 in the Y-axial direction. Based on a bridge area W*B of the bridge portion 104 in contact with the first electrode unit 101 is constant, if the second distance H2 of the touch sensor is equal to the first distance H1, the bridge portion 104 has a total length L0. According to some embodiments of the disclosure, the second distance H2 of the touch sensor 100 is shorter than the first distance H1. Thus, the total length L1 of the bridge portion 104 of some embodiments of the disclosure is decreased by two times the length of H1−H2, compared with the total length L0 of the above-mentioned bridge portion. In other words, L1=L0-2*(H1−H2). Therefore, the total length of the bridge portion 104 of the touch sensor 100 of the disclosure can be reduced to a length which is not visible to the human eye. The visual issue of the bridge portion of the conventional touch sensors is thereby overcome. Meanwhile, according to the embodiments of the disclosure, while the total length of the bridge portion 104 is reduced, the bridge area W*B of the bridge portion 104 in contact with the first electrode unit 101 is kept constant. Therefore, the touch sensor 100 can avoid an electrostatic issue occurring at the ends of the bridge portion 104 in contact with the first electrode units 101.

In some embodiments, the difference between the second distance H2 and the first distance H1 can be in a range of about 1 μm to about 25 μm. For example, the second distance H2 is about 5 μm to about 20 μm, while the first distance H1 is about 20 μm to about 30 μm. When the total length L0 of the above-mentioned bridge portion is above 200 μm, a visible problem is produced in the touch sensors. According to some embodiments of the disclosure, the total length L1 of the bridge portion 104 can be reduced to about 150 μm. The visible problem of the bridge portion is thereby overcome.

In one preferred embodiment, the difference between the second distance H2 and the first distance H1 can be in a range of about 10 μm to about 15 μm. In addition, the total length L1 of the bridge portion 104 can be above 150 μm according to the requirements for the design of the touch sensors.

Furthermore, in some embodiments, the width W of the bridge portion 104 can be in a range of about 6 μm to about 12 μm, preferably in a range of about 8 μm to about 10 μm. Moreover, the distance B from an end of the bridge portion 104 to the adjacent side of the isolation portion 103 can be in a range of about 30 μm to about 35 μm.

Referring to FIG. 2, a cross section of a touch sensor 100 along a cross section line 2-2′ of FIG. 1 according to some embodiments of the disclosure is shown. The first electrode units 101, the second electrode units 102 (not shown in FIG. 2) and the connection portions 102C of the second electrode units 102 of the touch sensor 100 are formed on a substrate 110. In some embodiments, the substrate 110 can be a glass substrate or a flexible plastic substrate. The substrate 110 can be attached onto a display panel (not shown in FIG. 2) through an adhesive layer (not shown in FIG. 2), for example an optical clear adhesive (OCA). The display panel is, for example a liquid-crystal display (LCD) panel or an organic light-emitting diode (OLED) display panel. The touch sensor 100 is combined with the display panel to form a touch display device.

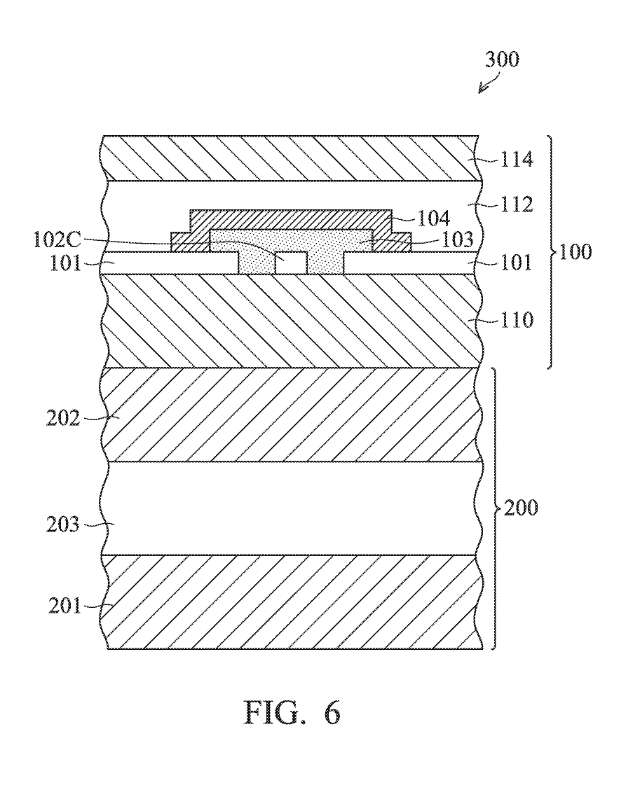

As shown in FIG. 2, in some embodiments, the isolation portion 103 is formed on the connection portions 102C of the second electrode units 102 and a portion of the first electrode units 101. The bridge portion 104 is formed on the isolation portion 103 to electrically connect the adjacent first electrode units 101 together. Next, referring to FIG. 6, a cross section of a touch display device 300 according to some embodiments of the disclosure is shown. The touch display device 300 includes a touch sensor 100 disposed above a display panel 200. The touch sensor 100 usually includes a protection layer 112 completely covering the first electrode units 101, the second electrode units 102 and the bridge portion 104. Another glass substrate 114 can be disposed on the protection layer 112 and used as a cover plate of the touch sensor 100. The display panel 200 includes a first substrate 201, a second substrate 202 and a display element layer 203 sandwiched between the first substrate 201 and the second substrate 202. In the embodiment of FIG. 6, the touch sensor 100 is a GG-type touch sensor which has touch-sensing elements formed on the glass substrate 110 between the cover plate 114 and the display panel 200.

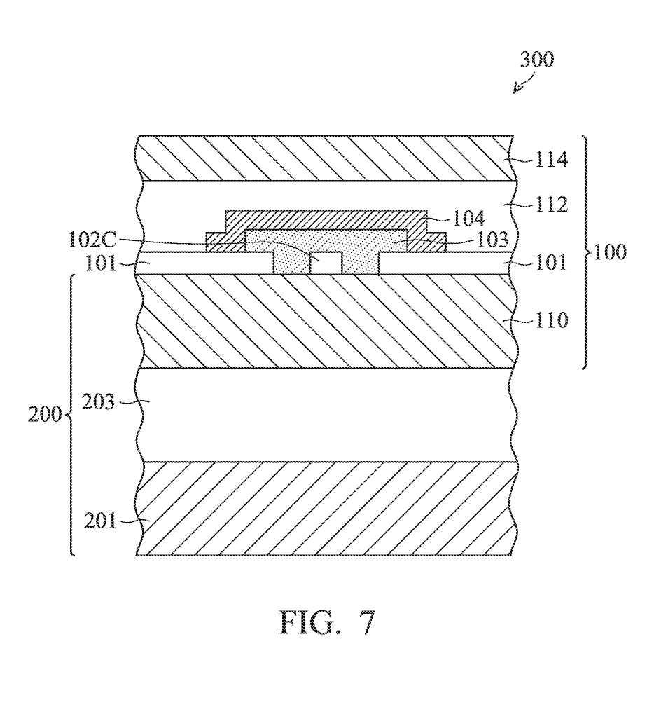

Referring to FIG. 7, a cross section of a touch display device 300 according to some other embodiments of the disclosure is shown. The touch display device 300 includes a touch sensor 100 disposed above a display panel 200. In some other embodiments, the substrate 110 can be the second substrate of the display panel 200. In the embodiments, the first electrode units 101, the second electrode units 102, the connection portions 102C, the isolation portion 103 and the bridge portion 104 of the touch sensor 100 are formed directly on the outside surface of the second substrate of the display panel 200. In the embodiment of FIG. 7, the touch sensor 100 is a touch on display (TOD) type touch sensor which has touch-sensing elements formed on the display panel 200.

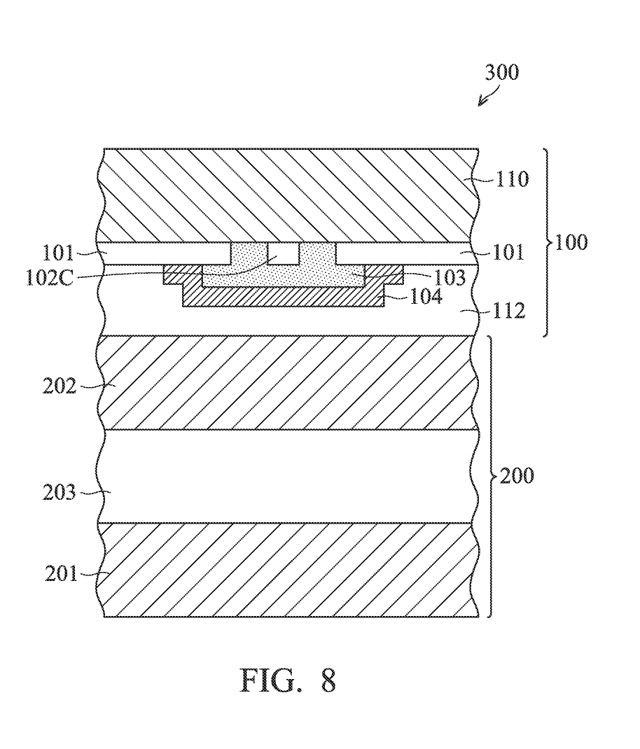

Referring to FIG. 8, a cross section of a touch display device 300 according to some other embodiments of the disclosure is shown. The touch display device 300 includes a touch sensor 100 disposed above a display panel 200. In some other embodiments, the substrate 110 can be the cover plate of the display panel 200. In the embodiments, the first electrode units 101, the second electrode units 102, the connection portions 102C, the isolation portion 103 and the bridge portion 104 of the touch sensor 100 are formed directly on the inside surface of the cover plate (substrate 110) of the display panel 200. In the embodiment of FIG. 8, the touch sensor 100 is a window integrated sensor (WIS) type touch sensor which has touch-sensing elements formed on the cover plate of the display panel 200.

In some other embodiments, the bridge portion 104 can be formed firstly on the substrate 110. Then, the isolation portion 103, the first electrode units 101, the second electrode units 102 and the connection portions 102C are formed. In the embodiments, the bridge portion 104 is disposed under the first electrode units 101 and the connection portions 102C of the second electrode units 102.

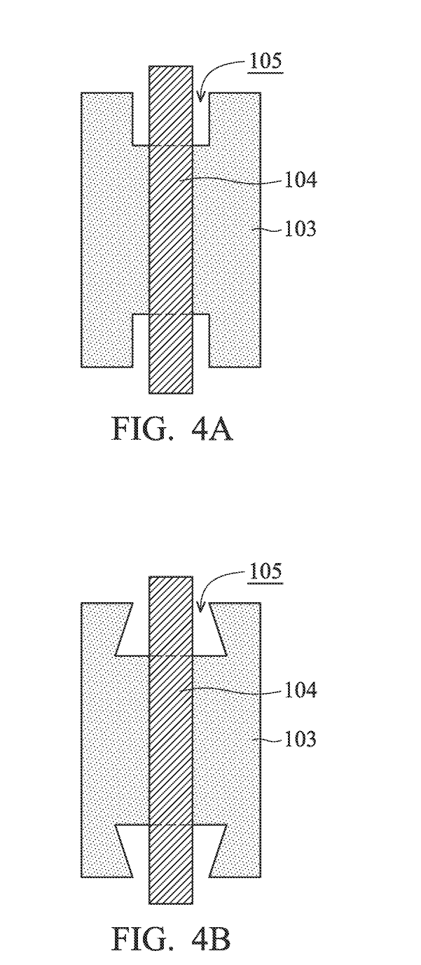

FIG. 3 shows a plane view of a portion of a touch sensor 100 according to some other embodiments of the disclosure. FIG. 3 only shows a portion of the first electrode units 101 and a portion of the second electrode units 102. In other words, FIG. 3 only shows a partial shape of the first electrode units 101 and a partial shape of the second electrode units 102. The difference between FIG. 3 and FIG. 1 is that two ends of the isolation portion 103 of the embodiment of FIG. 3 have respective indentations 105 at two ends of the isolation portion 103 along the first direction (the Y-axial direction). The isolation portion 103 overlaps with the bridge portion 104 along the third direction (the Z-axial direction). As shown in FIG. 3, the indentation 105 exposes a portion of the first electrode units 101. The indentation 105 has an opening part and a bottom part. The opening part of the indentation 105 has a width W_{T} and the bottom part of the indentation 105 has a width W_{B}. The indentation 105 has a depth D from the side of the isolation portion 103 to the bottom part of the indentation. According to some embodiments of the disclosure, the width W_{T} of the opening part of the indentation 105 is greater than the width W of the bridge portion 104. The width W_{B} of the bottom part of the indentation 105 can be shorter than, equal to, or greater than the width W of the bridge portion 104.

In the embodiments of FIG. 3, based on the bridge area W*B of the bridge portion 104 in contact with the first electrode unit 101 is constant, the second distance H2 of the touch sensor 100 is shorter than the first distance H1, and the indentation 105 has a depth D. The total length L2 of the bridge portion 104 of FIG. 3 is further decreased by two times the depth of D, compared with the total length L1 of the bridge portion 104 of the embodiment of FIG. 1. In other words, L2=L0-2*(H1−H2+D). In this formula, in order to avoid a short circuit occurring between the first electrode unit 101 and the second electrode unit 102, the maximum depth D is less than the distance D1. The distance D1 is from the side of the isolation portion 103, not including the indentation 105, to the adjacent edge of the connection portions 102C of the second electrode unit 102 along the Y-axial direction. In other words, the maximum of the depth D in this formula is shorter than the distance D1.

In the embodiments of FIG. 3, the total length L2 of the bridge portion 104 of the touch sensor 100 is further decreased by a length of 2*D, compared with the total length L1 of the bridge portion 104 of the embodiment of FIG. 1. Therefore, the total length L2 of the bridge portion 104 of the touch sensor 100 is not visible by the human eye. The visible problem of the bridge portion is thereby overcome. Meanwhile, the bridge area W*B of the bridge portion 104 in contact with the first electrode unit 101 is kept constant. Thus, the touch sensor 100 can avoid electrostatic discharge (ESD) occurring at the ends of the bridge portion 104.

As shown in FIG. 3, a third distance Dl is defined from the side of the isolation portion 103, except the indentation 105, to the adjacent edge of the connection portions 102C of the second electrode unit 102 along the Y-axial direction. In some embodiments, the third distance Dl can be in a range of about 20 μm to about 60 μm. According to some embodiments of the disclosure, the indentation 105 of the isolation portion 103 has a depth D from the side of the isolation portion 103 to the bottom part of the isolation portion 103. The depth D can be about 5% to about 99% of the third distance D1, preferably in a range of about 30% to about 70% of the third distance D1. For example, the depth D can be one-third of the third distance Dl. In some embodiments, while the first distance H1 is about 20 μm to about 30 μm and the second distance H2 is about 10 μm to about 20 μm, the depth D of the indentation 105 of the isolation portion 103 can be about 10 μm.

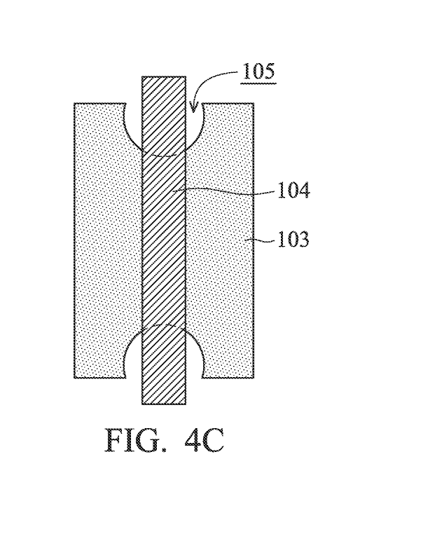

The embodiment of FIG. 3 shows the indentation 105 of the isolation portion 103 having the shape of a trapezoid with a bottom width W_{B} that is smaller than the opening width W_{T} of the indentation 105. However, in some other embodiments, the indentation 105 of the isolation portion 103 can have other shapes. FIGS. 4A-4C show plane views of a bridge portion 104 and an isolation portion 103 of the touch sensors 100 according to some embodiments of the disclosure. As shown in FIG. 4A, the indentation 105 of the isolation portion 103 has the shape of a rectangle with a bottom width W_{B} equal to the opening width W_{T} of the indentation 105. As shown in FIG. 4B, the indentation 105 of the isolation portion 103 has the shape of a trapezoid with a bottom width W_{B} that is greater than the opening width W_{T} of the indentation 105. In addition, as shown in FIG. 4C, the indentation 105 of the isolation portion 103 can have the shape of an arc. In the embodiments, the opening width W_{T} of the indentation 105 is greater than the width W of the bridge portion 104.

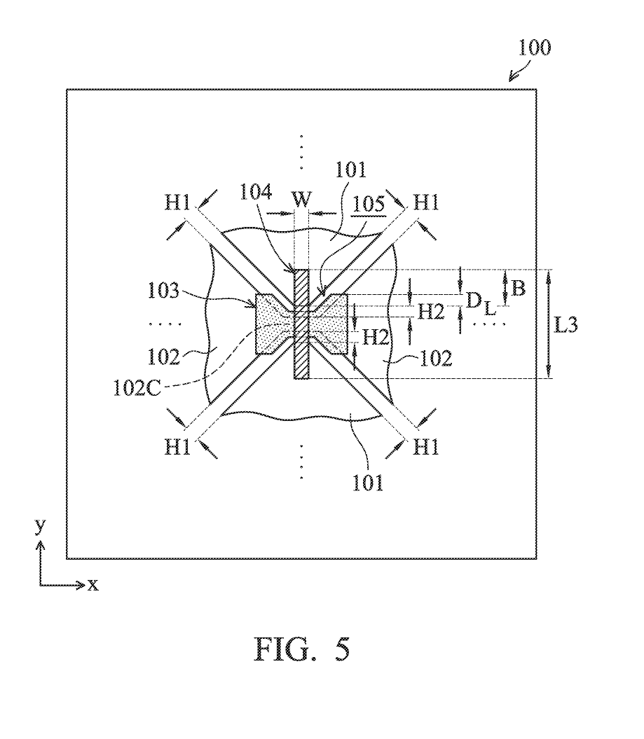

FIG. 5 shows a plane view of a portion of a touch sensor 100 according to some other embodiments of the disclosure. FIG. 5 only shows a portion of the first electrode units 101 and a portion of the second electrode units 102. In other words, FIG. 5 only shows a partial shape of the first electrode units 101 and a partial shape of the second electrode units 102. The isolation portion 103 of the embodiment of FIG. 5 has an indentation 105 to expose the first electrode units 101. The indentation 105 also exposes an area between the first electrode units 101 and the connection portions 102C of the second electrode unit 102. In addition, the indentation 105 of the isolation portion 103 further exposes an area between the first electrode units 101 and the adjacent second electrode units 102. Meanwhile, the isolation portion 103 further extends to overlap a portion of the second electrode units 102.

In the embodiment of FIG. 5, the bridge area W*B of the bridge portion 104 in contact with the first electrode unit 101 is constant and the second distance H2 of the touch sensor 100 is shorter than the first distance H1. The total length L3 of the bridge portion 104 of the embodiment of FIG. 5 is equal to L0-2*(H1−H2+D_{L}), i.e. L3=L0-2*(H1−H2+D_{L}). In this formula, a third distance D_{L} is defined between the side of the isolation portion 103, except the indentation 105, and the cut-off corner edge of the rhombus of the first electrode unit 101 along the Y-axial direction. The total length L3 of the bridge portion 104 of the touch sensor 100 of FIG. 5 is further decreased by a length of 2*D_{L}, compared with the total length L1 of the bridge portion 104 of the embodiment of FIG. 1. Therefore, the total length L3 of the bridge portion 104 of the touch sensor 100 is not visible by the human eye. The visible problem of the bridge portion is thereby overcome. Meanwhile, the bridge area W*B of the bridge portion 104 in contact with the first electrode unit 101 is kept constant. Thus, the touch sensor 100 can avoid an electrostatic issue occurring at the ends of the bridge portion 104.

According to some embodiments of the disclosure, using a layout wherein the second distance H2 between the first electrode unit and the connection portions of the second electrode unit is shorter than the first distance H1 between the first electrode unit and the second electrode unit, the total length of the bridge portion can be decreased by a length of two times (H1−H2). Moreover, using the depth D of the indentation of the isolation portion, the total length of the bridge portion can be further decreased by a length of two times (H1−H2+D). Therefore, the total length of the bridge portion in the touch sensors of the disclosure is not visible by the human eye. The visible problem of the bridge portion is thereby overcome. The visual effect of the touch sensors in appearance for users is thereby improved. Meanwhile, the bridge area of the bridge portion in contact with the first electrode unit is kept constant in the touch sensors of the disclosure. Thus, the touch sensors can avoid an electrostatic issue occurring at the ends of the bridge portion.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch display device, comprising:
a display panel;
a touch sensor disposed above the display panel, the touch sensor comprising:
a plurality of first electrode units arranged along a first direction;
a bridge portion electrically connecting the adjacent first electrode units with each other;
a plurality of second electrode units arranged along a second direction perpendicular to the first direction;
a connection portion electrically connecting the adjacent second electrode units with each other, wherein the connection portion intersects the bridge portion; and
an isolation portion disposed between the bridge portion and the connection portion,
wherein the first electrode unit is separated from the adjacent second electrode unit by a first distance, the first electrode unit is separated from the adjacent connection portion by a second distance, and the second distance is shorter than the first distance.

2. The touch display device of claim 1, wherein the isolation portion overlaps with the bridge portion, the isolation portion has an indentation at an end of the isolation portion along the first direction, the indentation has an opening part and a bottom part, and the opening part of the indentation has a width that is greater than a width of the bridge portion.

3. The touch display device of claim 2, wherein the isolation portion has a side indentation has a depth from the side of the isolation portion to the bottom part of the indentation, and the depth of the indentation is 5% to 99% of the third distance.

4. The touch display device of claim 2, wherein an area between the first electrode unit and the connection portion and an area between the first electrode unit and the second electrode unit are exposed by the indentation of the isolation portion.

5. The touch display device of claim 2, wherein the bottom part of the indentation has a width that is greater than a width of the bridge portion.

6. The touch display device of claim 1, wherein the difference between the first distance and the second distance is in a range of 1 μm to 25 μm.

7. A touch display device, comprising:
a display panel;
a touch sensor disposed above the display panel, the touch sensor comprising:
a plurality of first electrode units arranged along a first direction;
a bridge portion electrically connecting the adjacent first electrode units with each other;
a plurality of second electrode units arranged along a second direction perpendicular to the first direction;
a connection portion electrically connecting the adjacent second electrode units with each other, wherein the connection portion intersects the bridge portion; and
an isolation portion disposed between the bridge portion and the connection portion,
wherein the isolation portion overlaps with the bridge portion, the isolation portion has an indentation at an end of the isolation portion along the first direction, and the indentation has a width that is greater than a width of the bridge portion.

8. The touch display device of claim 7, wherein the isolation portion has a side being separated from an adjacent edge of the connection portion by a distance, the indentation has a depth from the side of the isolation portion to a bottom part of the indentation, and the depth of the indentation is 5% to 99% of the distance.

9. The touch display device of claim 7, wherein an area between the first electrode unit and the connection portion and an area between the first electrode unit and the second electrode unit are exposed by the indentation of the isolation portion.

10. The touch display device of claim 7, wherein the isolation portion extends onto a portion of the second electrode unit.
